(19) United States
(12) Patent Application Publication
(10) Pub. No.: US 2005/0211011 A1
(43) Pub. Date: Sep. 29, 2005

(54) Wheelchair mobility handle

(76) Inventors: Graham Victor, Maryborough (AU); Lynette Kym Victor, Maryborough (AU)

Correspondence Address: Daniel D. Chapman;JACKSON WALKER L.L.P., Suite 2100, 112 E. Pecan Street, San Antonio, TX, 78205, US

(21) Appl. No.: 11/088,503

(22) Filed: Mar. 24, 2005

(30) Foreign Application Priority Data
Mar. 26, 2004 (AU) 2004100221

(51) Int. Cl. B62M 1/14

(52) U.S. Cl. 74/551.1

(57) ABSTRACT

A wheelchair mobility handle (10) has a pair of arms (11 and 12) with ends (14 and 15) releasably engageable in the handles (105 and 205) of a wheelchair (100) or otherhand-propelled vehicle (200). The arms (11 and 12) are interconnectedby across-bar (13), where the first and second portions (18 and 20) are telescopically engaged and are urged apart by a compression coil spring (21) to enable the handle (10) to be fitted to wheelchairs (100) or hand-propelled vehicles (200) with handles (105 and 205) at a range of widths. The arms (11 and 12) maybe cranked to be substantially Z-shaped in side view to enable the cross-bar (13) to be above or below, the vertical height of the handles (105 and 205).

This application claims priority under 35 USC §119 from and incorporated herein by reference Australian Innovation Patent No. 2004100221, filed 26 Mar. 2004.

### FIELD OF THE INVENTION

This invention relates to a wheelchair mobility handle.

### BACKGROUND OF THE INVENTION

Throughout the specifications, the term “wheelchair” shall include other hand-propelled vehicles including golf buggies, hand carts, trolleys for loads and the like.

Carers pushing persons in wheelchair often find difficulty, due to the placement of the wheelchair handles. As the handles usually extend (10) rearwardly from the rear vertical frame member of the wheelchair, the carers often need to lean forward to ensure they do not trip on the wheels or knock their knees or shins on the wheelchair frame.

In addition, the handles extend horizontally from the frame and so the carers must “cock” their writs so that their hands can grip the handles.

As wheelchairs are of different sizes, e.g., widths and/or heights, the degree of difficulty encountered by the carers can be sufficient to discourage them from pushing the wheelchairs for any distance, thereby limiting the mobility of the persons in the wheelchairs.

### SUMMARY OF THE INVENTION

It is an object of the present invention to provide a handle attachable to wheelchairs (as hereinbefore defined) which makes it more comfortable for the carers to push the wheelchairs, including a handle which can be fitted to wheelchairs with handles at a range of widths.

It is further preferred object to provide a handle which can provide a cross-bar to be gripped at optional heights.

It is still further preferred object to provide a handle which may be folded when not required.

Other preferred objects of the present invention will become apparent from the following description.

In a broad aspect, the present invention resides in a wheelchair mobility handle including:
a pair of spaced, substantially parallel arms;
a cross-bar, to be gripped by a person to push the wheelchair, interconnecting the arms;
distal ends of the arms being releasably engageable in the cross-bar being of variable length to enable the spacing between the arms to be varied.

Preferably, the proximal end of each arm is telescopically receivable in or about each of the two handles on the wheelchair and has at least one spigot or pin releasably engageable in a slot or hole in the handle.

Preferably, the cross-bar has first and second portions wherein an end of the first portion is telescopically received in an end of the second portion, optional resilient means, such as a coil spring in the second portion engages the first portion to urge the portions to move the arms apart; and stop means between the first and second portions to limit the maximum spacing between the arms. Preferably, the resilient means is a compressible spring located within the second portion and engaged with the end of the first portion.

Optionally, the arms are of substantially Z-shape in side view so that the cross-bar, in use may be spaced above or below the vertical height of the handles on the wheelchair.

In a preferred embodiment of the handle, the arms are hingedly mounted on the cross-bar and are movable to a position lying adjacent the cross-bar when not in use.

### BRIEF DESCRIPTION OF THE DRAWING

To enable the invention to be fully understood, preferred embodiments will now be described with reference to the accompanying drawings, in which:

FIG. 1 is a side view showing a wheelchair fitted with the handle of the present invention;

FIG. 2 is a part-sectional perspective view of a first embodiment of the handle;

FIG. 3 is a side view showing the stop means in the handle;

FIG. 3A is a dimensional drawing to describe some preferred dimensions to applicant's mobility handle.

FIG. 4 is a perspective view of a second embodiment shown in alternative positions;

FIGS. 5 and 6 are respective part-sectional side elevational and top plan views illustrating the hinged mounting of one of the arms to the cross-bar; and

FIG. 7 is a side elevational view of the handle fitted to a hand cart or hand trolley.

FIG. 8A and 8B illustrate a preferred alternate embodiment of the mobility handle with some dimension.

### DETAILED DESCRIPTION OF THE PREFERRED EMBODIMENTS

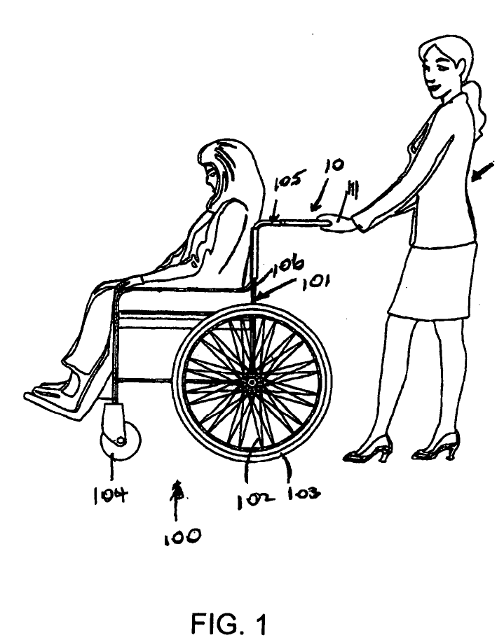

Referring to FIG. 1, a foldable wheelchair (100) has a main frame (101) supported by a pair of large rear wheels (102), with tyres (pneumatic or otherwise) (103), and typically, a pair of front castor wheels (104). A pair of wheelchair handles (105) extend rearwardly from the upper end of the vertical rear frame members (106) of the main frame (101).

A mobility handle (10) to be hereinafter described in more detail, is releasably engaged with the wheelchair handles (105) to enable the carer (110) to push the wheelchair (100) from a distance further rearwardly than for the wheelchair without the mobility handle (10); and where the carer's hands (111) apply a more natural gripping/pushing position.

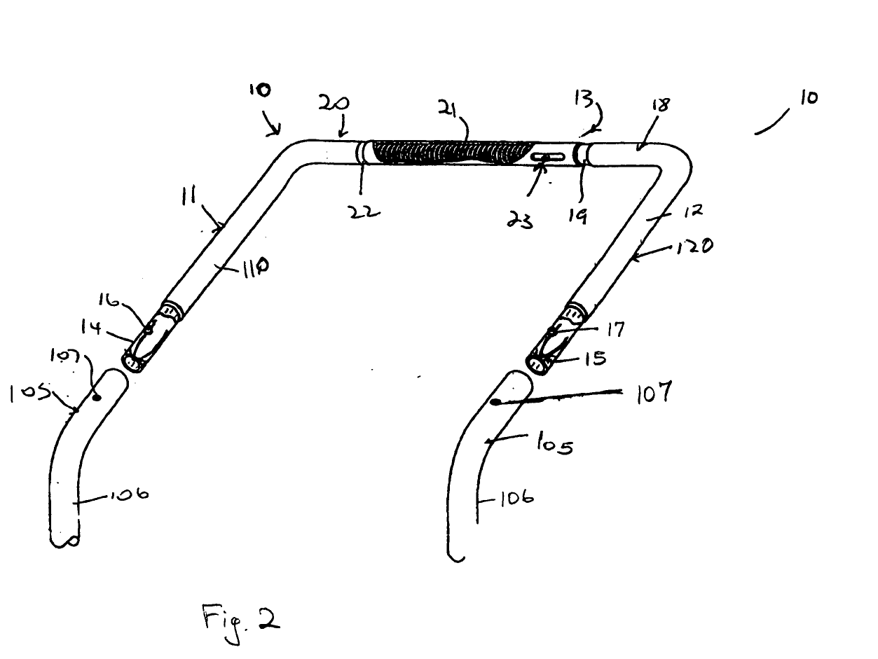

Referring to FIG. 2, the mobility handle (10) has a pair of spaced arms (11 and 12) having parallel members or portions (110 and 120). Aligned portions (18 and 20) form a cross-bar (13). Cross-bar (13) normally substantially horizontal in use and generally perpendicular to the arms and is typically round and dimensioned and adapted to be gripped by the carer's hands (111).

The proximal ends (14 and 15) of the arms (11 and 12) are releasably engageable within the handles (105) of the wheelchair (100) and maybe releasably securedby spring-loaded, hole engaged detent locking pins (16 and 17) releasably engageable in holes (107) in the wheelchair handles (105).

Cross-bar aligned portion (18) includes a reduced diameter end (19) to telescopically be slidably received in and forms an adjustable joint with an end of aligned portion (20). Portion (20) may include a crimped portion (22). A compression spring (21) maybe included in cross-bar(13) to assist in urging the cross-bar outward for selective locating proximal ends (14 and 15) in wheelchair handles having a variety of width spacing, yet in maintaining some tension in the arms. One end of the compression spring (21) engages reduced diameter end (19) of the aligned portion (18) and is operable to urge the aligned portions (18 and 20) apart so that the arms (11 and 12) are urged towards a maximum spacing width.

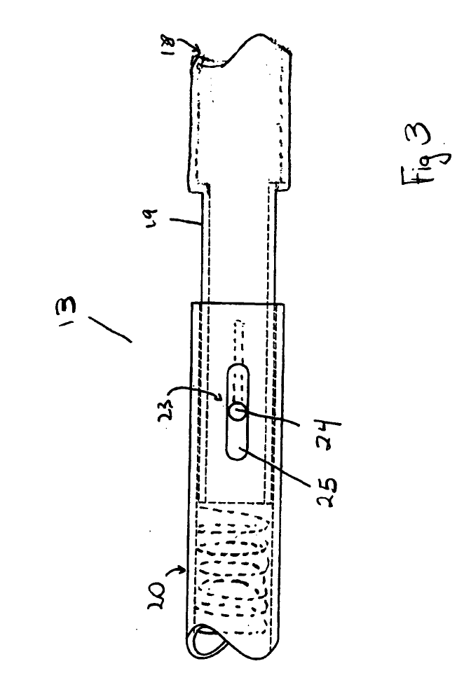

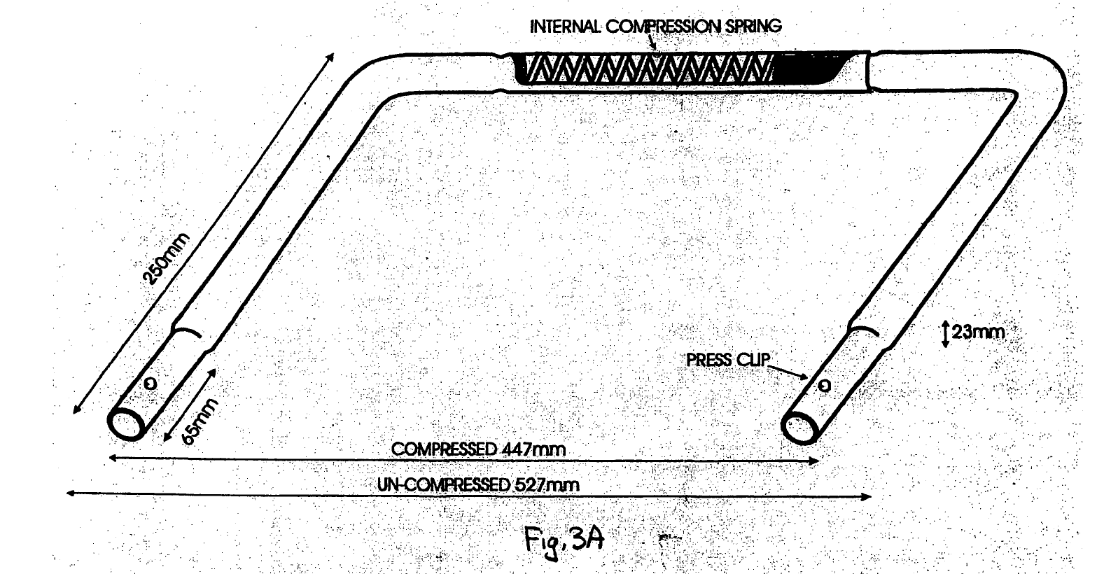

Stop means (23) are illustrated in more detail in FIG. 3. The stop means includes a spring loaded detent button or spigot (24) (for example, as used at 16 and 17) secured to the reduced diameter end (19) of aligned portion (18) received within a multiplicity of holes or an elongate slot (25) in the aligned portion (20) to thereby limit the relative range of movement and spacing of the first and second aligned portions (18 and 20) of the cross-bar (13) and thereby, the range of spacings between the arms (11 and 12) to enable the mobility handle (10) to be used with handles of a wide range of wheelchairs (100), for example, between 447 mm and 527 mm, see FIG. 3A. These and other dimensions on FIG. 3A are recommended ranges.

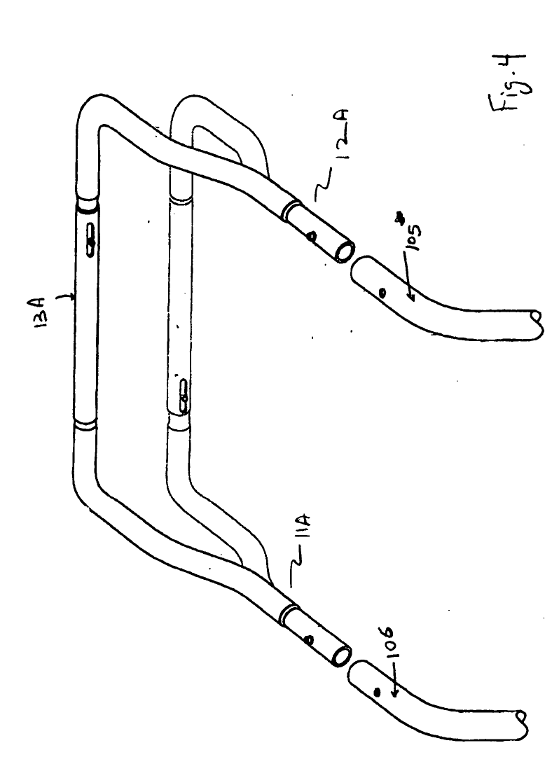

In an alternative preferred embodiment 10A shown in FIG. 4, the arms (11A and 12A) are “cranked” into a substantially Z-shape in side view so that the cross-bar (13A ) can be located at a height above (shown in solid lines) or below (upside down), the vertical height of the wheelchair handles (105) (another pair of holes being necessary in the wheelchair handles (105)). This enables carers (110) of different heights to comfortably push the wheelchair (100). FIG. 4 also shows that this or any other embodiment of the wheelchair handle may be used without the compression spring.

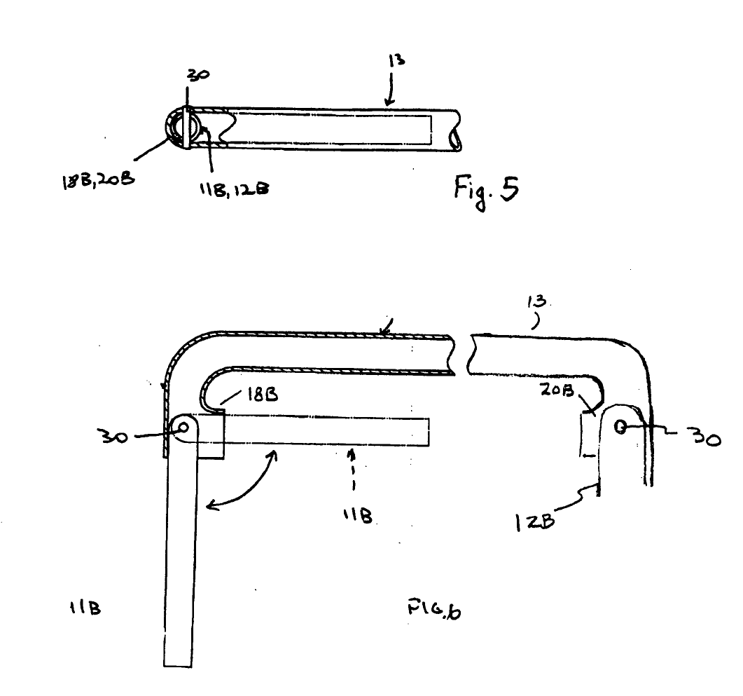

Referring to FIGS. 5 and 6, an alternate embodiment of arms (11B and 12B) are adapted to be hingedly mounted, via pivot pins (30) in sockets (18B and 20B) provided at the ends of the cross-bar (13B) to enable the arms (11B and 12B) to be folded to lie substantially parallel to the cross-bar (13B) for transport, or when the mobility handle is not in use.

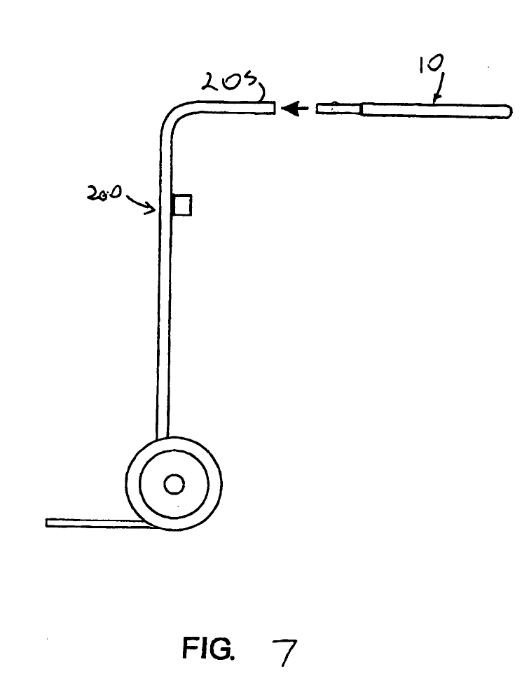

As shown in FIG. 7, the mobility handle (10) in any of its embodiments may be used with other hand-propelled vehicles such as a hand cart (200) where the handle (10) is releasably engaged with the hand cart handles (205) in the manner hereinbefore described or any manner described herein.

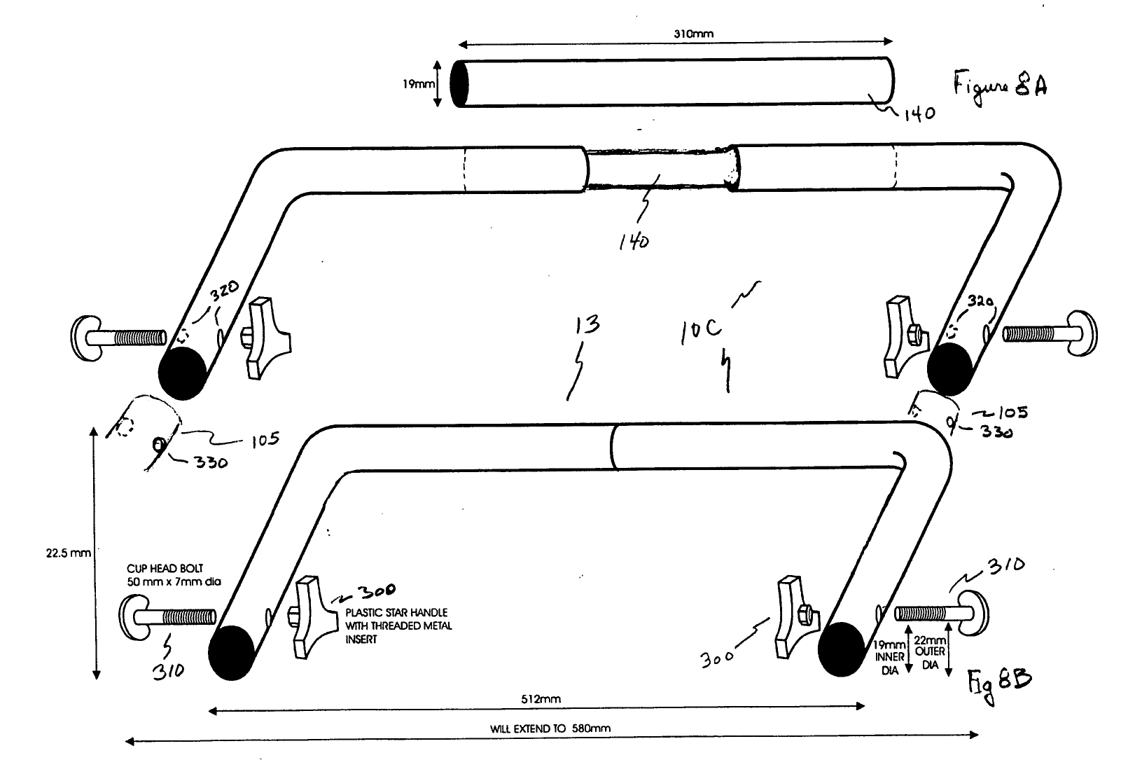

FIGS. 8A and 8B illustrate a preferred embodiment of mobility handle (10C) wherein the cross-bar (13) at the joint or engagement of the two aligned portions includes a spacer bar (140) that fits telescopically into the aligned portions without use of a spring. Threaded star handles (300) engage cup head bolts (310) and holes (320) are aligned with holes (330) in wheelchair handles (105) (see FIG. 8A) to provide a means for an threadably engaging and securing the mobility handle to the wheelchair without the use of tools. FIG. 8A and 8B illustrate alternate recommended dimension ranges.

It will be readily apparent to the skilled addressee that the handle (10) of the present invention provides a more comfortable means for the carer (110) to propel the wheelchair (100) or other hand-propelled vehicle (200), where the handle (10) can be easily adjusted to suit wheelchair handles (105) at different spacings and/or different carer heights, and the handle (10) maybe easily folded for transport or when not in use.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

1. A mobility handle for engagement with a pair of handles of a wheelchair, the mobility handle comprising:
a pair of spaced, substantially parallel arm members having a pair of proximal ends, the proximal ends adapted to removably engage pair of handles of the wheelchair; and
a cross-bar engaged with the spaced apart arm members but generally perpendicular thereto, the cross-bar including means for joining the spaced apart arms.

2. The mobility handle of claim 1 wherein the cross-bar includes a joint to engage one of the arms to the other.

3. The mobility handle of claim 2 wherein the cross-bar includes a first aligned portion and a second aligned portion, the two aligned portions telescopically joined at the joint.

4. The mobility handle of claim 3 further including a spring engaging the first portion and the second portion to urge the arms apart.

5. The mobility handle of claim 4, the cross-bar further including a slot in the first portions or the second portion and a stop member in the other of the first portion or the second portion to limit the range of motion between the two portions.

6. The mobility handle of claim 2 wherein the joint of the cross-bar includes an insert member telescopically received into the two aligned portions so that the two portions may be selectively spaced apart to adapt the proximal ends of the two arm members to the width of the handles of the wheelchair.

7. The mobility handle of claim 2 wherein the proximal ends of the arm members include holes and detent springs for releasable engagement with the handles of the wheelchair.

8. The mobility handle of claim 7 wherein the joint is adapted to telescopically join the first and second portions of the cross-bar.

9. The mobility handle of claim 8 further including a spring engaging the first portion and the second portion to urge the arms apart.

10. The mobility handle of claim 2 wherein the joint includes the first portion and the second portion and an insert member, the two portions slidably joined by the insert member telescopically received into the two portions so that they may be selectively spaced apart to adapt the proximal ends of the arm members to the width of the handles of the wheelchair.

11. The mobility handle of claim 2 wherein the arms include bent portions so as to place the cross-bar selectively above or below the handles of the wheelchair.

12. The mobility handle of claim 2 further including a pivot means to join the cross-bar to each of the arms.

13. The mobility handle of claim 10 wherein the arms include bent portions so as to place the cross-bar selectively above or below the handles of the wheelchair.

14. The mobility handle of claim 10 further including a pivot means to join the cross-bar to each of the arms.

15. The mobility handle of claim 10 further including means to limit the distance between the spacing of the two portions joined by the insert member.

16. The mobility handle of claim 10 wherein the proximal ends of the arm members include holes and detent springs for releasable engagement with the handles of the wheelchair.

17. The mobility handle of claim 10 wherein the proximal ends of the arms include threaded fasteners.

18. The mobility handle of claim 17 wherein the threaded fasteners include a bolt and nut adapted to be engaged without the use of tools.
